(19) United States
(12) Patent Application Publication
(10) Pub. No.: US 2024/0386063 A1
(43) Pub. Date: Nov. 21, 2024

(54) CONTEXT BASED NATURAL LANGUAGE GENERATION SYSTEM

(71) Applicant: Quantum Blue, Inc., Chicago, IL (US)

(72) Inventors: Kenji Toyooka, Ottawa (CA); David L. Newman, Tampa, FL (US); Reginald A. Holmes, Pasadena, CA (US)

(21) Appl. No.: 18/650,627

(22) Filed: Apr. 30, 2024

Related U.S. Application Data
(60) Provisional application No. 63/463,193, filed on May 1, 2023.

(51) Int. Cl. G06F 16/9532; G06F 16/9538

(52) U.S. Cl. CPC G06F 16/9532; G06F 16/9538

(57) ABSTRACT

The present invention pertains to providing a browser for running searches of at least one database, presenting a first search result by the browser, using a first search term to determine a context for the words of the first search term, using the context in order to present a second search result, the second search result including at least one phoneme based term from the first search result and using Artificial Intelligence (AI) to run a context-based search of the first search term.

The present application claims the benefit of priority to Provisional U.S. Patent Application No. 63/463,193, filed May 1, 2023; the aforementioned priority application being hereby incorporated by reference in its entirety.

### BACKGROUND

The present invention pertains to a word alternatives generation system and software algorithm for generating alternative words or phrases. In some embodiments, Artificial Intelligence (AI) is used and in particular machine learning programs such as natural language/ChatGPT (Chat Generative Pre-trained Transformer) may be used to allow for iterative interaction between a user and the AI system. The system can receive input via a keyboard or by spoken words. In some embodiments, the system may be used to generate alternative words or phrases to generate new brand names to be registered as a domain name or trademark.

### SUMMARY

A computer system is provided for word selection comprising a computing device for running a browser, the browser run non-remotely, the browser for running searches of at least one database. Presenting a first search result by the browser. In an embodiment, using a first search term to determine a context for the words of the first search result. Using the context in order to generate a second search result, the second search result including at least one phoneme based term from the first search result.

A search indicator may be provided that provides indication as to whether the second search result is available, the search indicator presented separately from the second search result and using Artificial Intelligence (AI) to run a context-based search of the first search result.

The search indicator may be one of a check mark or an “x,” each of the marks to indicate whether the second search term is available for registration as a domain name. The search indicator may be one of a check mark or an “x,” each of the marks to indicate whether the second search term is available for registration as a trademark. Wherein at least two databases are searched simultaneously in order to improve searching speed of the computer system and to rapidly indicate whether the first search term is available for registration as a trademark or domain name.

The browser may use an alternatives block. The browser may use a phoneme combinator. The browser may use a context box. A query engine may be used. The browser may utilize a watch tower service to track when a search term has been searched by a known entity. The step of searching the database may comprise one of the following subject matters: airline reservations, hotel reservations, lodging reservations, theater reservations, stock exchange pricing, dining reservations, social networks, library, real estate listings, automobile, dating sites, weather events, product safety ratings, travel warnings, on-line betting, sports betting, trademarks, domain names, color and automobile damage.

The AI search is used to find an alternative to the first search result. Wherein the AI may be ChatGPT. The AI may be generative AI. A machine learning algorithm may be used to undertake a context based search of the first search result. A Large Language Model (LLM) may be used to undertake a context based search of the first search result. Wherein a business to business data base is established using AI. The database may comprise a data set including a brand name available as both a trademark and domain name. The brand name result may be filtered according to context. The context may be provided by a classification of goods and services. The brand name result is filtered according to “alive” or “dead” status listing.

In an embodiment, a context based language system is provided comprising a processor and a memory to store a set of instructions wherein the processor accesses the instructions to conduct a search of databases comprising the steps of: running a browser, the browser run non-remotely, the browser for running searches of at least two databases, presenting a first search result by the browser, using the first search result to determine a context for the words of the first search result, using the context in order to present a second search result, the second search result including at least one phoneme based term from the first search result and using Artificial Intelligence (AI) to run a context-based search of the first search result.

The present invention is an interactive text and visual user interface (UI) designed to help users explore, manipulate and generate existing and invented words in order to develop brand names and other useful English-based terms for use in business, trademarks and creative endeavors.

To provide users with high quality results, the present invention may employ the use of AI (e.g. Generative AI; Large Language Model (LLM); OpenAI's GPT-4). In an embodiment, several APIs (e.g. Words API, Datamuse API, Domain Search API) may be used. In another embodiment, a trademark database (e.g. TESS2, TSDR) updated from USPTO data, and other local databases in combination to, may be used not only find similar or related words to the user's search term, but to extensively manipulate words through the use of a dynamic modular natural language query system (e.g. query engine).

Some examples of what users may be able to do with the present invention: Find synonyms, antonyms, related words, rhymes, slang, trigger words and common follow-up words to any word or phrase. Retrieve definitions, examples, etymologies and frequency tables for any word or phrase. Search existing trademarks and domains that contain any word or phrase.

Invent new words, business names, generate potential tag lines, and proper names using combinations of words. See suggestions for logo designs, color schemes/palettes, font types and other branding ideas generated by the AI based on a user's history. Create custom queries and combinations of term manipulations to further expand the repertoire offered by the Query Engine.

Using any of the content generated by the present invention, users can then: Save their work in their online account so that they can resume at any point; Apply for a trademark (for any term deemed potentially available); Register a domain (for any term determined as available); Offer other services that can be subsequently modularly added, like logo design, branding consultations, graphic design, web design, trademark consultations, etc.; Notification system for account owners to inform them of searches/uses of specific terms; and AI assistant system that provides suggestions during the development of a project.

All text content generated by the present invention may be easily manipulated by the user with a lightweight drag and drop UI system that exists on top of the website HTML/CSS. This allows for rapid editing, moving, copying and deleting of words and phrases, and organizing texts into custom bins/paragraphs. This system makes it very easy for users to select parts of text to use or generate further content.

At the core of present invention is a query engine including an assembly of various APIs, AI interfaces and databases to help generate content (e.g. other databases). These typically take inputs of words or phrases and then generate relevant results. The modular aspect of the system allows for the results from different engines to be combined and re-inputted into another engine, thus allowing for extensive natural language manipulation of words. Additionally, custom engines can be created by the user by changing an AI query itself, using the word manipulation UI. This will allow users to develop a library of their own query engines.

### BRIEF DESCRIPTION OF THE DRAWINGS

FIG. 1 is flow diagram for the present invention;

FIG. 2 is a screen shot of an embodiment of the present invention;

FIG. 3 is a screen shot of another embodiment of the present invention;

FIG. 4 is a screen shot of another embodiment of the present invention;

FIG. 5 is a screen shot of another embodiment of the present invention;

FIG. 6 is a screen shot of another embodiment of the present invention; and

FIG. 7 is a block diagram of a computer system for the present invention.

### DETAILED DESCRIPTION

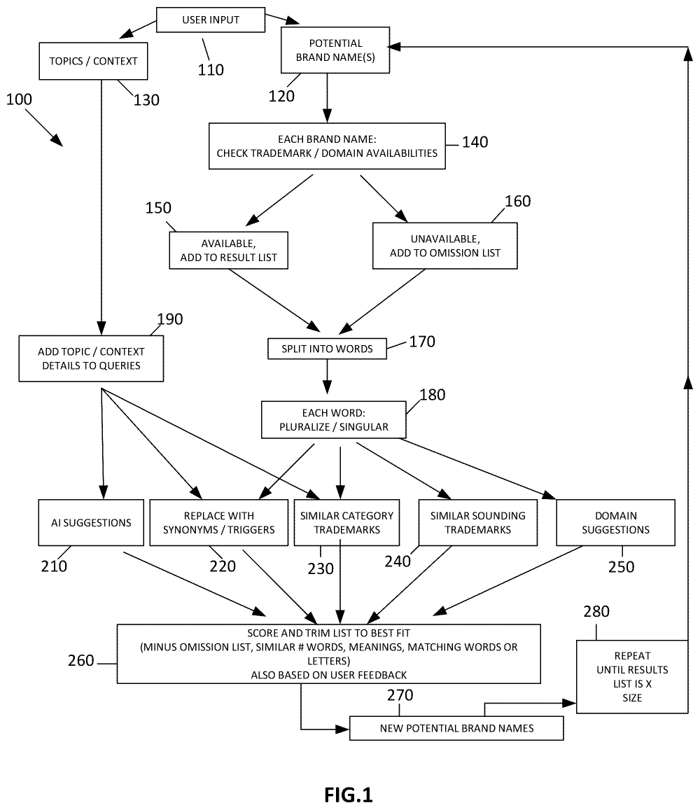

FIGS. 1-7 depict embodiments of the present invention. In an embodiment, the invention provides the following query engines:
(Find trademarks)—find trademarks that contain a term.
(Similar words)—find synonyms, slang, and examples of a word, phoneme or phrase.
(Invent a word)—take two or more words and combine them to create a new invented word.

A user can then create a custom query that combines all three in a specific order, so that with one click they can find, using the term “BLUE” for example:
BLUE->(Find trademarks)->QUANTUM BLUE->(Similar words)->ELECTROMAGNETIC AZURE->(Invent a word)->ELECTROZURE

Furthermore, they could create a custom AI Query using the word manipulation system, such as:
“What is a word prefix that denotes the same meaning as [TERM]?”

Which they could then use like any other query, and in combination with other queries:
WATER->(custom query)->HYDRO->(Find trademarks)->HYDROPONICS LTD.

Turning to FIG. 1, a flow diagram of the word generation query engine 100 is depicted. In the first step 110, user input of a word, phoneme or phrase is provided. The system allows for the user to select whether he/she wishes to have a potential brand name 120 analyzed and searched. At step 130, the context of the search term is analyzed and topics are developed using AI to help find similar search terms in later steps. For example, if “Remix My Room” is input at step 110, the context box could generate terms such as: mashup, song, soundtrack, music, recording, sound board, studio, submix, etc.

At step 140 each search term input is searched against a database. In an embodiment, the database may be a trademark database, such as the US Patent and Trademark Office (USPTO) TESS2 database for “live” or “dead” trademark registrations. In another embodiment, a domain name database can be searched to determine whether a domain name is available. In an embodiment, the system 100 may search a single database, or multiple databases simultaneously. For example, providing a combined result after searching the trademark database and domain name database could be very useful to a user who is starting up a new business or project.

At step 150, once the search term is determined to be available after searching the database(s) the search term is added to a results list. In the alternative, at step 160 the search term is found to be unavailable (already registered as a trademark and/or domain) the search term is added to an omission list. At step 170, the user may continue to use the query engine 100 in order to find alternatives to the originally input search term. In cases where the search term is a phrase or term with multiple syllables/phonemes, the term may be split into multiple search terms or phonemes.

At step 180, each singularized word is pluralized and each pluralized word is singularized to be sure as many alternatives are considered by the system. In an embodiment, at step 190 context details are inserted into the queries, so that the AI system can broaden the range of alternative terms/phonemes to provide for consideration. At step 210 AI suggestions to context are provided. In an embodiment, the AI can be provided by an algorithm that automatically outputs alternative words or phonemes; or only upon selection of the AI feature by the user to provide further context to the search term.

At step 220, the system can replace terms or phonemes with synonyms or other trigger words. At step 230, similar categories may be selected for providing trademarks. For example, the USPTO classification categories may be used to identify and select similar categories and terms or phonemes. The AI system may be trained to identify similar USPTO classification categories and to select the top (n) categories and make alternatives suggestions based on such classifications.

At step 240, similar sounding terms are identified. In an embodiment, a trademark database can be prepared according to the sound of phonemes and searched against the sound of the search term input 120. Using the dialect, based on the location of the user, may be preferred and the AI system can be trained to identify a user location based on the zip code input by the user.

At step 250, the search term is compared to domain names to see if the alternative term or phoneme is available. At step 260, the system analyzes the results from steps 210 to 250 and scores the best alternatives. In an embodiment, a scoring mechanism can be used such as a list of most popular Google terms. In an alternative embodiment, any “dead” trademarks could be scored higher than those trademarks that match that are “alive.” The list of alternatives may be trimmed in other ways, such as using the context of the originally input search term to find the best fit or match. The list may be further trimmed (or filtered) by omitting any terms from the omissions list obtained at step 160. In another embodiment, a similar number of words as the originally input search term can be selected, or similar meanings, or matching words, letters of phonemes. In another embodiment, user feedback is obtained by providing check boxes next to alternative terms.

At step 270, based on all of the above, the system can add the alternative terms to a list of potential new terms. In an embodiment, it may be a list of potential new brand names to be used for a new business or project or service. The list may be generated with an indicator column along with each new term that identifies whether the new term is available for registration (e.g. trademark registration or domain registration).

At step 280 the above process is repeated until a list of appropriate size is provided. For example, if a user of the system is promised 20 alternative “available” terms, the system can be programmed to run through step 280 until x=20.

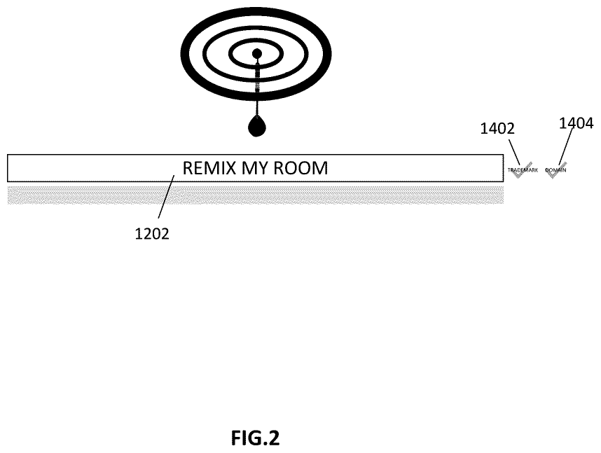

Turning to FIG. 2-6, screen shots of such a user interface (UI) are provided by a browser that are controlled by a microprocessor or browser to present first and second search results. At FIG. 2, a screen shot of a search input bar is shown 1202 with the term “Remix My Room” input. The browser is programmed to automatically conduct a search of a first database and compare the first database with the first search term (first input) with the first database. Search term indicator marks 1402, 1404 are displayed separately from the first search term, but integrated as part of the user interface on the same screen as the first search term 1202.

In an embodiment, the indicator mark 1402, 1404 is a “check” mark that indicates that the search term is available. In an embodiment the indicator mark 1402, 1404 is a green color. As shown in FIG. 2, a first indicator mark 1402 indicates that the first search term is available to be registered as a trademark. A second indicator mark 1404 indicates that the first search term is available to be registered as a domain name. Thus, it is understood that a first database was searched by the browser and that no matching search terms were found in a trademark data base (resulting in the first indicator mark 1402) and no matching terms were found in a second (domain name) database (resulting in the second indicator mark 1404).

Alternative search indicator marks may be displayed, such as an “x”. In an embodiment, the indicator mark may be the color red. In an embodiment, the indicator mark may indicate that the first search term is not available for registration (e.g. either as a trademark or domain name). In an embodiment, additional databases may be searched and corresponding additional indicator marks may be displayed by the browser adjacent the search bar containing the first search term 1202.

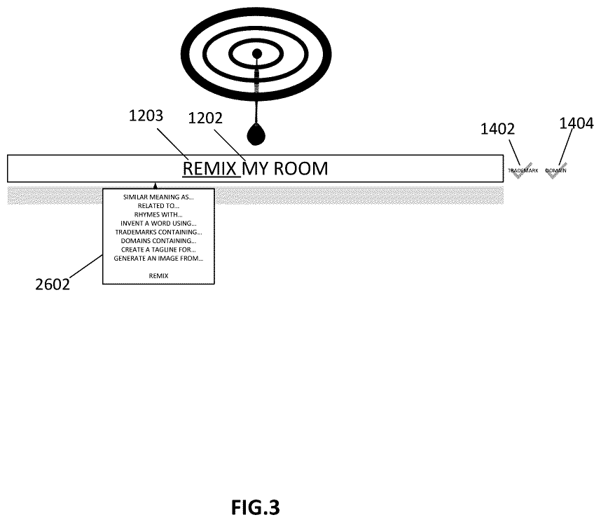

Turning to FIG. 3, the first search term 1202 is presented in the search bar. As depicted, the first search term “Remix My Room” is displayed and adjacent to the search bar are indicator marks 1402, 1404 (as discussed previously). An options box 2602 is displayed as a drop down menu (that drops down from the term “Remix”). In an embodiment, the options box is automatically displayed once a phoneme/term (e.g. “Remix”) 1203 of the first search term (e.g. “Remix My Room”) 1202 is hovered over by a mouse (or touched when using a touch screen). The options box 2602 may include multiple next steps to be undertaken with respect to the first phoneme (e.g. “Remix”). In an embodiment, such options may include: similar meaning as, related to, rhymes with, invent a word using, trademarks containing, domains containing, create a tagline for or generate an image from, etc. Once the option is clicked-on (or selected in any other way), the option selected is implemented with respect to the initial phoneme or term (see steps 210-250 above).

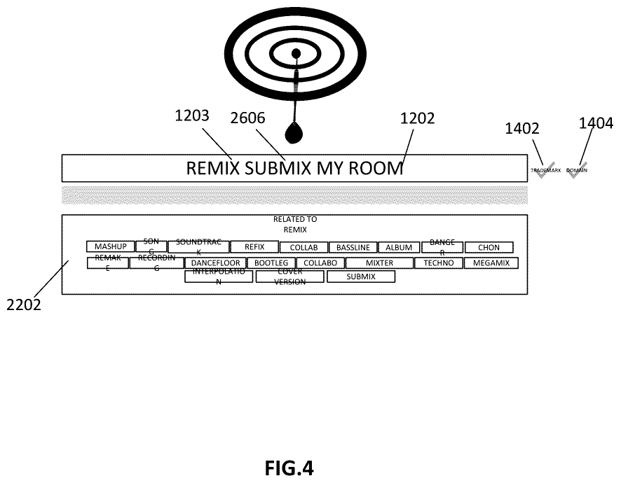

Turning to FIG. 4, step 260, discussed above, is described in more detail. After selecting phoneme 1203 and selecting “related to” from options box 2602, the browser inserts “Submix” into search term 1202. So the entire search term is “Remix Submix My Room” in the search bar. Below the search bar is context suggestions box 2202. The context box 2202 includes a list of second search term options, including “Submix.” The browser has inserted the “Submix” term from the list of context box items 2202, upon selection by a user or automatically by ranking the context terms.

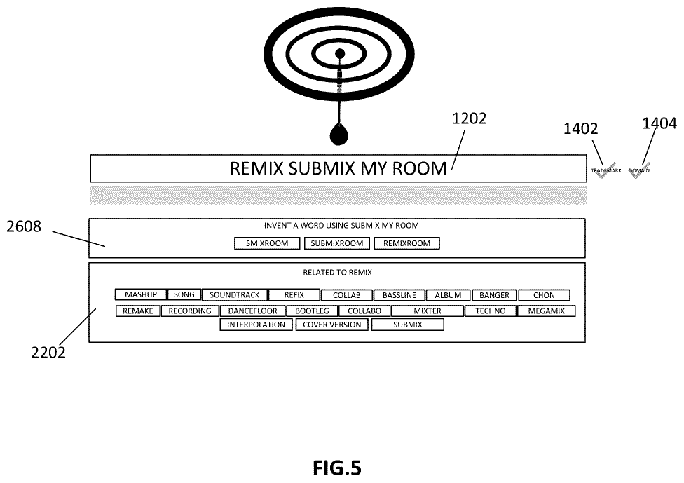

Turning to FIG. 5, a further step in creating an alternative search term is provided. Below the search bar that contains accumulation of search terms (e.g. “Remix Submix My Room”) 1202 is alternatives box 2608. In an embodiment, the alternatives box 2608 includes the “Invent a word” results list. Using an algorithm, the browser uses AI to create a new word (e.g. “nonsense”) from “Submix My Room”. Options such as “Smixroom,” “Submixroom” or “Remixroom” are developed using phoneme combinator mechanism (e.g. combination of phonemes to create a new search term) to invent a new word (e.g. second search term).

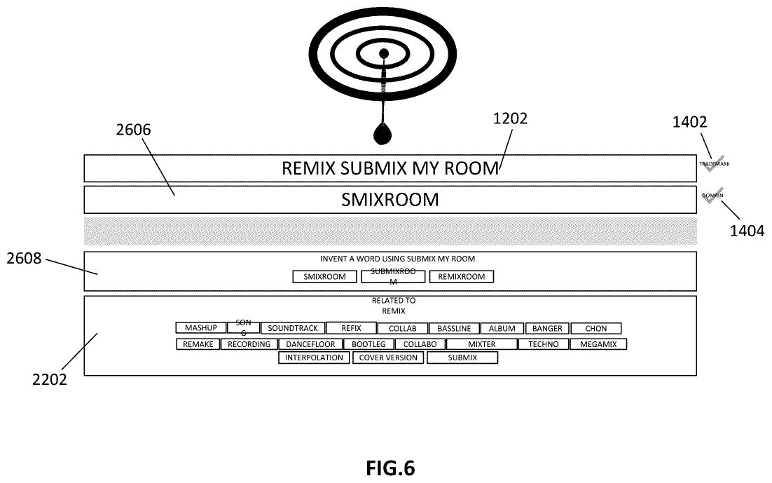

Turning to FIG. 6, a full screen shot is depicted showing a composite of the search steps conducted including first search term 1202 and second search term 2606. In particular, first search term (e.g. “Remix Submix My Room”) 1202 is depicted and second search term (e.g. “Smixroom”) 2606 is depicted. Those search terms result from alternatives box 2608 (e.g. “Smixroom”) and context box 2202 (e.g. “Submix”) in order to populate the search bars. Thus, it can be understood that by using AI and a smart browser a user can start with a first search term (e.g. “Remix My Room”) 1202 and finally end-up with a second search term (e.g. “Smixroom”) 2606, resulting from use of an alternatives box 2608 and context box 2202.

During each step, search indicator marks appear adjacent to the search bar. For example, as displayed in FIG. 6, it can be seen that a search of the trademark database shows that first search term 1202 is available and depicts “available” indicator mark 1402 and shows that second search term 2606 is available and depicts “available” indicator mark 1404.

In an embodiment, the context function provides for searching of the database using subject matter categories. For example, a classification system may be used in order to filter the database search results so that they eliminate all topics not related to a particular subject matter/context. In an embodiment, the subject matter categories may be provided according to the trademark international classification listing of 45 classes of goods and services. Below are listed the services classifications: Advertising and business (class 35); Insurance and financial (class 36); Building construction and repair (class 37); Telecommunications (class 38); Transportation and storage (class 39); Treatment of materials (class 40); Education and entertainment (class 41); Computer and scientific (class 42); Hotels and restaurants (class 43); Medical, beauty and agriculture (class 44); and Personal and legal (class 45). Also included are the classification for goods 1-34.

In an embodiment the present system provides a context based search according to FIG. 6. The context box 2202 may be selected to include class 41 (Education and entertainment) and, using AI, a search result is returned that selects alternative brand names related to education and entertainment services.

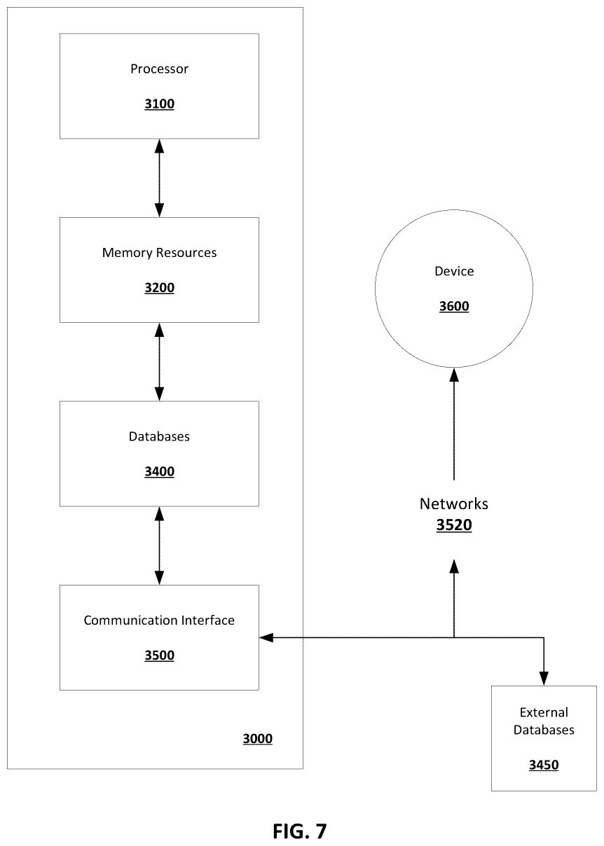

Turning to FIG. 7, a block diagram of a computer system for a context based natural language generation system is provided. A computer system 3000 is depicted, upon which embodiments described herein may be implemented. A computer system 3000 can be implemented on, for example, a server or combination of servers 3000. For example, the computer system 3000 may be implemented as part of a network service for providing searching services. In the context of FIG. 1, some or all of the functionality described with a dual search system may be implemented using computer system and server 3000. Likewise, a method such as described with an example of FIGS. 2-6 may also be implemented using computer system and server 3000.

In one implementation, the computer system and server include processing resources, memory resources 3200 (e.g., read-only memory (ROM) or random access memory (RAM)), databases 3400 and a communication interface 3500. The computer system includes at least one processor 3100 to process information (including storing temporary variables) and execute instructions stored in the memory resources. The computer system may also include additional storage devices for storing static information and instructions for the processor 3100. A storage device such as a magnetic disk or optical disk for storing information and instructions is provided.

The communication interface 3500 enables the computer system to communicate with one or more client devices 3600, over one or more networks (e.g., cellular network) 3520 through use of the network link (wireless or a wire). The communication interface may also communicate with external databases 3450. In particular, the computer system 3000 may use memory resources to store executable instructions that can be executed on the computer system to configure browsers and/or browser-enabled applications of respective client devices 3600, in order to implement functionality such as described with a server 3000 of an example of FIGS. 1-6. As an addition or variation, the computer system may transfer scripts, browser logic, plugins or other instructions to client computers in order to enable a distributed computing platform on which page rendering functionality such as described with an example of FIGS. 1-6 may be provided.

Examples described herein are related to the use of the computer system for implementing the techniques described herein. According to an aspect, techniques are performed by the computer system in response to the processor 3100 executing one or more sequences of one or more instructions contained in the memory resources 3200. Such instructions may be read into the memory resources from another machine-readable medium, such as a storage device. Execution of the sequences of instructions contained in the memory resources may cause the processor 3100 to perform the process steps described herein. In alternative implementations, hard-wired circuitry may be used in place of or in combination with software. Provided above are only particular embodiments of the invention provided as examples. However, the full scope of the present invention is to be found in the claims provided below and interpreted according to one of ordinary skill in the art.

What is claimed is:

1. A computer system for word selection comprising:
a computing device for running a browser, the browser run non-remotely;
the browser for running searches of at least one database;
generating a first search result by the browser of a first search term;
selecting a context that describes subject matter of the first search term;
using the context in order to generate a second search result, the second search result including at least one phoneme based term from the first search term; and
using Artificial Intelligence (AI) to run a context-based search of the first search term.

2. The computer system of claim 1 wherein a search result indicator that provides indication as to whether the second search result is available, the search indicator presented separately from the second search result; and the search indicator is one of a check mark or an “x,” each of the marks to indicate whether the second search term is available for registration as a domain name or a trademark.

3. The word selection system of claim 1 wherein at least two databases are searched simultaneously in order to improve searching speed of the computer system and to rapidly indicate whether the first search term is available for registration as a trademark or domain name.

4. The computer system of claim 1 wherein the browser uses an alternatives block.

5. The computer system of claim 1 wherein the browser uses a phoneme combinator.

6. The computer system of claim 1 wherein the browser uses the first search term to determine the context that describes the subject matter of the first search term.

7. The computer system of claim 1 wherein a query engine is used to provide a dynamic modular natural language system.

8. The computer system of claim 1 wherein the browser utilizes a watch tower service to track when a search term has been searched by a known entity.

9. The computer system of claim 1 comprising the step of searching the database comprising one of the following subject matters:
airline reservations, hotel reservations, lodging reservations, theater reservations, stock exchange pricing, dining reservations, social networks, library, real estate listings, automobile, dating sites, weather events, product safety ratings, travel warnings, on-line betting, sports betting, trademarks, domain names, color and automobile damage.

10. The computer system of claim 1 wherein the AI search is used to find an alternative to the first search result.

11. The computer system of claim 1 wherein the AI is ChatGPT.

12. The computer system of claim 1 wherein the AI is generative AI.

13. The computer system of claim 1 wherein a machine learning algorithm is used to undertake a context based search of the first search result.

14. The computer system of claim 1 wherein a Large Language Model (LLM) is used to undertake a context based search of the first search result.

15. The computer system of claim 1 wherein a business to business data base is established using AI.

16. The computer system of claim 15 wherein the database comprises a data set including a brand name available as both a trademark and domain name.

17. The computer system of claim 16 wherein the brand name result is filtered according to context.

18. The computer system of claim 17 wherein the context is provided by a classification of goods and services.

19. The computer system of claim 17 wherein the brand name result is filtered according to “alive” or “dead” status listing.

20. A context based language system comprising a processor and a memory to store a set of instructions wherein the processor accesses the instructions to conduct a search of databases comprising the steps of:
running a browser, the browser run non-remotely;
the browser for running searches of a first search term and from at least two databases;
presenting a first search result by the browser;
using the first search term to determine a context for the first search term;
using the context in order to generate an alternative search result, wherein the context is selected by the processor from a list of classifications; and
using Artificial Intelligence (AI) to run a context-based search of the first search term in order to generate an alternative search result to the first search result, the alternative search result being available as a trademark or domain name.
